(19) United States
(12) Patent Application Publication
(10) Pub. No.: US 2020/0361615 A1
(43) Pub. Date: Nov. 19, 2020

(54) SOLID-PROPELLANT GAS DRIVEN COMPRESSOR FOR EVACUATION SLIDE INFLATION

(71) Applicant: GOODRICH CORPORATION, Charlotte, NC (US)

(72) Inventors: Kevin Mueller, Dixon, CA (US); Brian Wilson, Vacaville, CA (US)

(73) Assignee: GOODRICH CORPORATION, Charlotte, NC (US)

(21) Appl. No.: 16/415,777

(22) Filed: May 17, 2019

(51) Int. Cl. B64D 25/14; C06D 5/04

(52) U.S. Cl. CPC B64D 25/14; C06D 5/04

(57) ABSTRACT

An inflation system is disclosed. In various embodiments, the inflation system includes a solid-propellant gas generator; and a gas motor having a turbine coupled to the solid-propellant gas generator and a compressor configured for coupling to an inflatable device.

### FIELD

The present disclosure relates generally to inflatable evacuation systems and, more particularly, to methods and apparatus used to rapidly inflate such systems during deployment.

### BACKGROUND

Inflatable evacuation systems may be found on various structures, including aircraft, boats, off-shore drilling platforms and the like. The systems are typically equipped with an inflatable device, such as, for example, an inflatable slide or an inflatable raft, configured to facilitate rapid evacuation of persons in the event of an emergency situation. The slides or rafts are typically stored in an uninflated condition on the structure—e.g., a commercial aircraft—to be evacuated in a location readily accessible for deployment. A common manner of inflation includes the use of a pressurized container in conjunction with an aspirator whereby ambient air as well as gas from the pressurized container inflate one or more tubes that comprise the slide or the raft. The aspirator employs a venturi to aid in drawing in ambient air from the atmosphere to help inflate the tubes. Increasing the size of the container that supplies the pressurized gas is not always satisfactory as doing so may disproportionally increase the mass carried by the aircraft. Other manners of inflation include solid-propellant gas generators configured to direct a compressed gas directly into the slide or the raft or indirectly through a venturi, such that the slide or the raft is inflated with both the compressed gas and the ambient air. One drawback to using a gas generator is the temperature of the compressed gas is typically high, requiring the temperature to be reduced prior to the compressed gas being introduced into the slide or the raft.

### SUMMARY

An inflation system is disclosed. In various embodiments, the inflation system includes a solid-propellant gas generator; and a gas motor having a turbine coupled to the solid-propellant gas generator and a compressor configured for coupling to an inflatable device.

In various embodiments, the solid-propellant gas generator is coupled to the turbine via a first conduit. In various embodiments, the compressor is configured for coupling to the inflatable device via a second conduit. In various embodiments, the compressor is configured to receive a low pressure air from an atmosphere and compress the low pressure air to provide a compressed air stream for inflating the inflatable device. In various embodiments, the turbine is configured to receive a high pressure gas stream generated by the solid-propellant gas generator and to exhaust the high pressure gas stream as a turbine exhaust stream to the atmosphere.

In various embodiments, the inflation system includes a manifold having a first inlet coupled to the turbine, a second inlet coupled to the compressor and an outlet configured for coupling to the inflatable device. In various embodiments, the first inlet is configured to receive a turbine exhaust stream exiting the turbine and the second inlet is configured to receive a compressed air stream exiting the compressor. In various embodiments, the outlet is configured to provide a mixed stream to the inflatable device, the mixed stream comprising the turbine exhaust stream and the compressed air stream.

In various embodiments, the inflation system includes a heat exchanger configured to receive a turbine exhaust stream from the turbine and to output a cooled exhaust stream. In various embodiments, the inflation system further includes a manifold having a first inlet coupled to the heat exchanger, a second inlet coupled to the compressor and an outlet configured for coupling to the inflatable device. In various embodiments, the first inlet is configured to receive the cooled exhaust stream exiting the heat exchanger and the second inlet is configured to receive a compressed air stream exiting the compressor. In various embodiments, the outlet is configured to provide a mixed stream to the inflatable device, the mixed stream comprising the cooled exhaust stream and the compressed air stream.

An evacuation system for an aircraft is disclosed. In various embodiments, the evacuation system includes an evacuation slide; a solid-propellant gas generator; and a gas motor having a turbine coupled to the solid-propellant gas generator and a compressor coupled to the evacuation slide.

In various embodiments, the solid-propellant gas generator is coupled to the turbine via a first conduit and the compressor is coupled to the evacuation slide via a second conduit. In various embodiments, the compressor is configured to receive a low pressure air from an atmosphere and compress the low pressure air to provide a compressed air stream for inflating the evacuation slide and the turbine is configured to receive a high pressure gas stream generated by the solid-propellant gas generator and to exhaust the high pressure gas stream as a turbine exhaust stream to the atmosphere.

In various embodiments, the evacuation system includes a manifold having a first inlet coupled to the turbine and configured to receive a turbine exhaust stream exiting the turbine, a second inlet coupled to the compressor and configured to receive a compressed air stream exiting the compressor, and an outlet coupled to the evacuation slide and configured to provide a mixed stream to the evacuation slide, the mixed stream comprising the turbine exhaust stream and the compressed air stream.

In various embodiments, the evacuation system includes a heat exchanger configured to receive a turbine exhaust stream from the turbine and to output a cooled exhaust stream and a manifold having a first inlet coupled to the heat exchanger, a second inlet coupled to the compressor and coupled to the evacuation slide and configured to provide a mixed stream to the evacuation slide, the mixed stream comprising the cooled exhaust stream from the heat exchanger and a compressed air stream from the compressor.

A method of inflating an evacuation slide is disclosed. In various embodiments, the method includes the steps of igniting a solid-propellant housed within a container to generate a compressed gas; routing the compressed gas through a turbine section of a gas motor to generate a compressed air stream via a compressor section connected to the turbine section; and routing the compressed air stream to the evacuation slide.

In various embodiments, the step of routing the compressed air stream to the evacuation slide includes combining, in a manifold, the compressed air stream with an exhaust stream from the turbine section to form a mixed stream of the compressed air stream and the exhaust stream and routing the mixed stream to the evacuation slide. In various embodiments, the step of routing the compressed air stream to the evacuation slide includes combining, in a manifold, the compressed air stream with a cooled exhaust stream from a heat exchanger coupled to the turbine section to form a mixed stream of the compressed air stream and the cooled exhaust stream and routing the mixed stream to the evacuation slide.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the following detailed description and claims in connection with the following drawings. While the drawings illustrate various embodiments employing the principles described herein, the drawings do not limit the scope of the claims.

FIG. 1 is a schematic view of an evacuation slide coupled to an aircraft, in accordance with various embodiments;

FIG. 2 is a schematic view of an inflation system, in accordance with various embodiments;

FIG. 3 is a schematic view of an inflation system, in accordance with various embodiments;

FIG. 4 is a schematic view of an inflation system, in accordance with various embodiments; and

FIG. 5 is a flow chart depicting various steps of inflating an evacuation slide, in accordance with various embodiment.

### DETAILED DESCRIPTION

The following detailed description of various embodiments herein makes reference to the accompanying drawings, which show various embodiments by way of illustration. While these various embodiments are described in sufficient detail to enable those skilled in the art to practice the disclosure, it should be understood that other embodiments may be realized and that changes may be made without departing from the scope of the disclosure. Thus, the detailed description herein is presented for purposes of illustration only and not of limitation. Furthermore, any reference to singular includes plural embodiments, and any reference to more than one component or step may include a singular embodiment or step. Also, any reference to attached, fixed, connected, or the like may include permanent, removable, temporary, partial, full or any other possible attachment option. Additionally, any reference to without contact (or similar phrases) may also include reduced contact or minimal contact. It should also be understood that unless specifically stated otherwise, references to “a,” “an” or “the” may include one or more than one and that reference to an item in the singular may also include the item in the plural. Further, all ranges may include upper and lower values and all ranges and ratio limits disclosed herein may be combined.

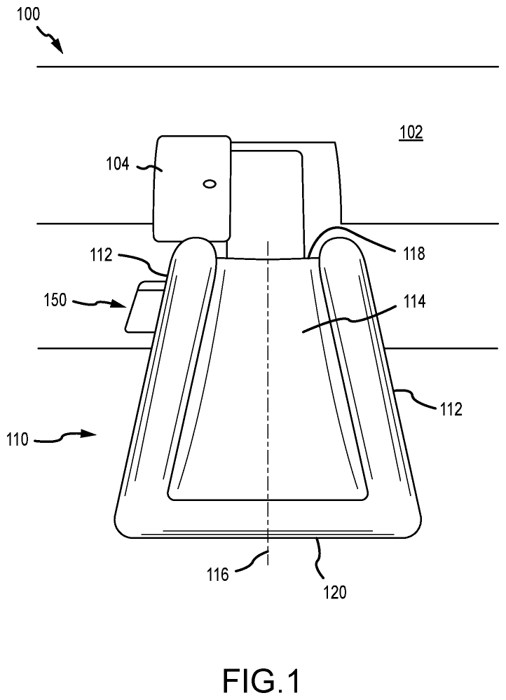

Referring to FIG. 1, an aircraft 100 having an evacuation slide 110, according to various embodiments, is illustrated. The aircraft 100 may include a fuselage 102 with wings fixed to the fuselage 102. An emergency exit door 104 may be disposed on the fuselage 102 over one of the wings or at some other location along a length of the fuselage 102. The evacuation slide 110 and other components of an evacuation system may be housed within a pack-board housing or other compartment mounted to the aircraft 100. The evacuation system may jettison a blowout panel to deploy the evacuation slide 110, such as, for example, an inflatable evacuation slide, in response to the emergency exit door 104 opening or in response to another evacuation event. FIG. 1 schematically depicts the evacuation slide 110 in a deployed state, extending from the fuselage 102 of the aircraft 100. During deployment, one or more inflatable tubes 112 are inflated using an inflation system 150. The evacuation slide may comprise a sliding surface 114 secured to the inflatable tubes 112 and configured for sliding passenger egress from the emergency exit door 104 of the aircraft 100 to a surface on the ground in the event of an evacuation on land or to a water surface in the event of an evacuation on a lake, river or ocean. In various embodiments, the evacuation slide 110 includes a longitudinal axis 116 that extends from a first or proximal end 118 to a second or distal end 120. In various embodiments, as described further below, the inflation system 150 includes a solid-propellant gas generator coupled to a gas motor that comprises a turbine and a compressor configured to inflate the evacuation slide 110.

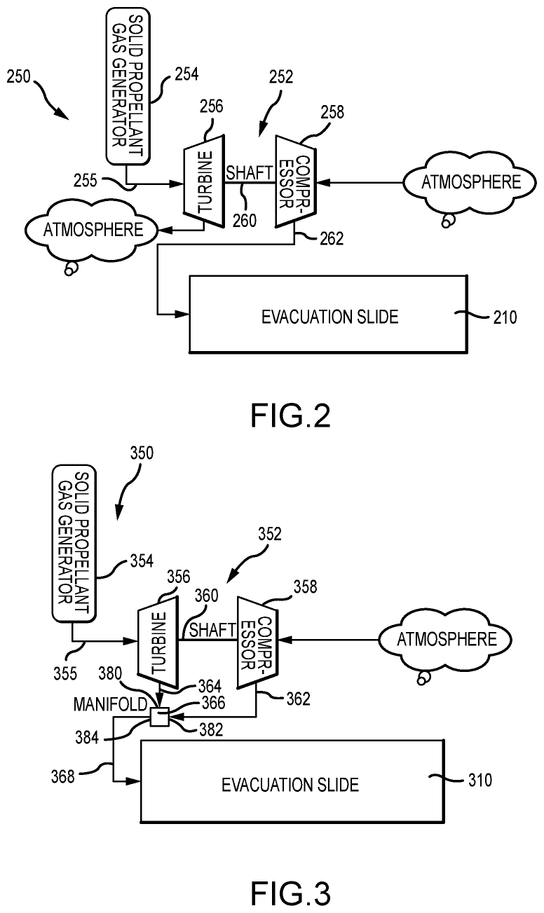

Referring now to FIG. 2, an inflation system 250, similar to the inflation system 150 described above with reference to FIG. 1, is illustrated. In various embodiments, the inflation system 250 includes a gas motor 252 coupled to a solid-propellant gas generator 254. The gas motor 252 may comprise a turbine 256 and a compressor 258. In various embodiments, the turbine 256 and the compressor 258 may be rotatably coupled together by a shaft 260. A first conduit 255 (or a pressurized gas supply conduit) couples the solid-propellant gas generator 254 to the turbine 256 and serves to provide a high pressure gas stream generated by the solid-propellant gas generator 254 to drive the turbine 256. A second conduit 262 (or a pressurized air conduit) couples the compressor 258 to an evacuation slide 210, similar to the evacuation slide 110 described above with reference to FIG. 1.

In operation, a solid-propellant housed within the solid-propellant gas generator 254 is ignited to generate the high pressure gas stream. The high pressure gas stream is routed via the first conduit 255 to the turbine 256, where the high pressure gas stream impinges upon a plurality of turbine blades connected to a turbine rotor housed within the turbine 256, causing the shaft 260 to rotate. Rotation of the shaft 260 causes a compressor rotor having a plurality of compressor blades housed within the compressor 258 to rotate. Rotation of the compressor blades within the compressor 258 causes low pressure air from the atmosphere to be sucked into the compressor 258 and pressurized to form a compressed air stream. The compressed air stream from the compressor 258 is then routed to the evacuation slide 210 via the second conduit 262 to inflate the evacuation slide 210 from a deflated state to an inflated state. During inflation of the evacuation slide 210, the high pressure gas stream routed to the turbine via the first conduit 255, resulting in rotation of the compressor rotor within the compressor 258, is exhausted as a turbine exhaust stream to the atmosphere.

Referring now to FIG. 3, an inflation system 350, similar to the inflation system 150 described above with reference to FIG. 1, is illustrated. In various embodiments, the inflation system 350 includes a gas motor 352 coupled to a solid-propellant gas generator 354. The gas motor 352 may comprise a turbine 356 and a compressor 358. In various embodiments, the turbine 356 and the compressor 358 may be rotatably coupled together by a shaft 360. A first conduit 355 (or a pressurized gas supply conduit) couples the solid-propellant gas generator 354 to the turbine 356 and serves to provide a high pressure gas stream generated by the solid-propellant gas generator 354 to drive the turbine 356. A second conduit 362 (or a pressurized air conduit) couples the compressor 358 to an evacuation slide 310, similar to the evacuation slide 110 described above with reference to FIG. 1, via a manifold 366, which is also configured to receive a turbine exhaust stream exiting the turbine 356 via a third conduit 364 (or a turbine exhaust conduit) to form a mixed stream comprising the compressed air stream and the turbine exhaust stream. In various embodiments, the manifold 366 includes a first inlet 380 coupled to the turbine 356 and configured to receive the turbine exhaust stream, a second inlet 382 coupled to the compressor 358 and configured to receive the compressed air stream and an outlet 384 configured for coupling to the evacuation slide 310 and for providing the mixed stream to the evacuation slide 310.

In operation, a solid-propellant housed within the solid-propellant gas generator 354 is ignited to generate the high pressure gas stream. The high pressure gas stream is routed via the first conduit 355 to the turbine 356, where the high pressure gas stream impinges upon a plurality of turbine blades connected to a turbine rotor housed within the turbine 356, causing the shaft 360 to rotate. Rotation of the shaft 360 causes a compressor rotor having a plurality of compressor blades housed within the compressor 358 to rotate. Rotation of the compressor blades within the compressor 358 causes low pressure air from the atmosphere to be sucked into the compressor 358 and pressurized to form a compressed air stream. The compressed air stream from the compressor 358 is then routed to the manifold 366, which is configured to combine the compressed air stream with the turbine exhaust stream exiting the turbine 356 via the third conduit 364 (or a turbine exhaust conduit) to form the mixed stream of the compressed air stream and the turbine exhaust stream. The mixed stream is then routed to the evacuation slide 310 via a fourth conduit 368 (or a mixed stream supply conduit) positioned between the manifold 366 and the evacuation slide 310 to inflate the evacuation slide 310 from a deflated state to an inflated state.

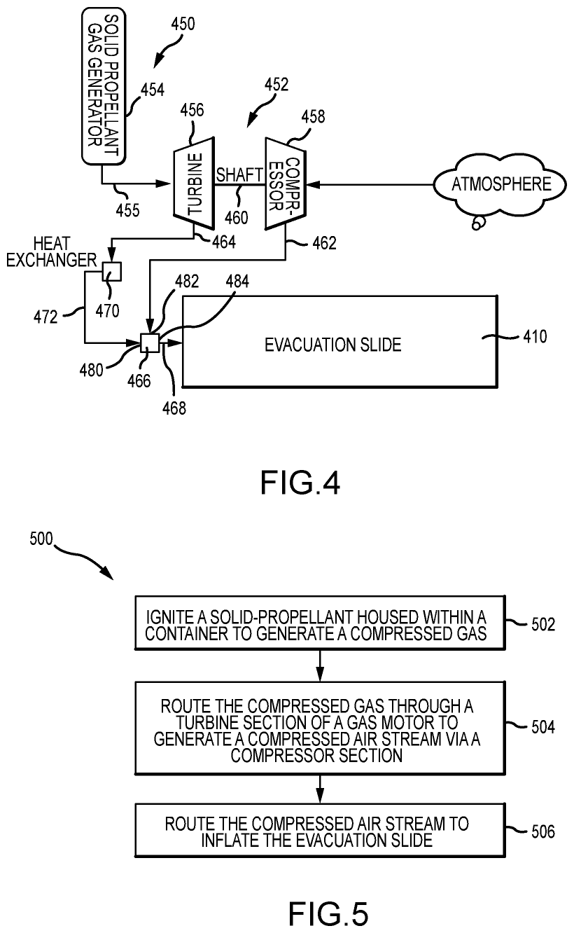

Referring now to FIG. 4, an inflation system 450, similar to the inflation system 150 described above with reference to FIG. 1, is illustrated. In various embodiments, the inflation system 450 includes a gas motor 452 coupled to a solid-propellant gas generator 454. The gas motor 452 may comprise a turbine 456 and a compressor 458. In various embodiments, the turbine 456 and the compressor 458 may be rotatably coupled together by a shaft 460. A first conduit 455 (or a pressurized gas supply conduit) couples the solid-propellant gas generator 454 to the turbine 456 and serves to provide a high pressure gas stream generated by the solid-propellant gas generator 454 to drive the turbine 456. A second conduit 462 (or a pressurized air conduit) couples the compressor 458 to an evacuation slide 410, similar to the evacuation slide 110 described above with reference to FIG. 1, via a manifold 466, which is also configured to receive a cooled exhaust stream exiting a heat exchanger 470 via a fifth conduit 472 (or a cooled exhaust conduit) to form a mixed stream comprising the compressed air stream and the cooled exhaust stream. A third conduit 464 (or a turbine exhaust conduit) is configured to route the turbine exhaust stream to the heat exchanger 470. In various embodiments, the manifold 466 includes a first inlet 480 coupled to the turbine 456 and configured to receive the turbine exhaust stream, a second inlet 482 coupled to the compressor 458 and configured to receive the compressed air stream and an outlet 484 configured for coupling to the evacuation slide 410 and for providing the mixed stream to the evacuation slide 410.

In operation, a solid-propellant housed within the solid-propellant gas generator 454 is ignited to generate the high pressure gas stream. The high pressure gas stream is routed via the first conduit 455 to the turbine 456, where the high pressure gas stream impinges upon a plurality of turbine blades connected to a turbine rotor housed within the turbine 456, causing the shaft 460 to rotate. Rotation of the shaft 460 causes a compressor rotor having a plurality of compressor blades housed within the compressor 458 to rotate. Rotation of the compressor blades within the compressor 458 causes low pressure air from the atmosphere to be sucked into the compressor 458 and pressurized to form a compressed air stream. The compressed air stream from the compressor 458 is then routed to the manifold 466, which is configured to combine the compressed air stream with the cooled exhaust stream exiting the heat exchanger 470 via the fifth conduit 472 to form the mixed stream comprising the compressed air stream and cooled exhaust stream. The mixed stream is then routed to the evacuation slide 310 via a fourth conduit 468 (or a mixed stream supply conduit) positioned between the manifold 466 and the evacuation slide 410 to inflate the evacuation slide 410 from a deflated state to an inflated state.

Referring now to FIG. 5, a method 500 of inflating an evacuation slide is described, in accordance with various embodiments. In a first step 502, a solid-propellant housed within a container is ignited to generate a compressed gas. In a second step 504, the compressed gas is routed through a turbine section of a gas motor to generate a compressed air stream via a compressor section connected to the turbine section. In a third step 506, the compressed air stream is routed to and used to inflate the evacuation slide. In various embodiments, the compressed air may be combined in a manifold with an exhaust stream from the turbine section to form a mixed stream of compressed air and turbine exhaust, which is then routed to and used to inflate the evacuation slide. In various embodiments, the compressed air may be combined in a manifold with a cooled exhaust stream from a heat exchanger to form a mixed stream of compressed air and cooled turbine exhaust, which is then routed to and used to inflate the evacuation slide.

The foregoing disclosure provides apparatus and methods used to inflate an inflatable device, such as, for example, an evacuation slide. In various embodiments, a solid-propellant gas generator is used to drive a radial inflow turbine connected to a centrifugal compressor via a shaft. The compressor is used to inflate the evacuation slide with a compressed air stream. The exhaust stream exiting the turbine can either be directed to mix with the compressed air stream and aid in the slide inflation or wasted to the atmosphere. By using the hot gas from the gas generator to drive the turbine attached to the compressor, the heat of the gas can be converted to mechanical work and, thereby, increase the inflation potential of the gas generator. In instances where the turbine exhaust stream remains too hot to be used with the compressed air to inflate the slide, the turbine exhaust stream may be wasted to the atmosphere or passed through an additional heat exchange to further reduce the temperature.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Different cross-hatching is used throughout the figures to denote different parts but not necessarily to denote the same or different materials.

Systems, methods and apparatus are provided herein. In the detailed description herein, references to “one embodiment,” “an embodiment,” “various embodiments,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112(f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Finally, it should be understood that any of the above described concepts can be used alone or in combination with any or all of the other above described concepts. Although various embodiments have been disclosed and described, one of ordinary skill in this art would recognize that certain modifications would come within the scope of this disclosure. Accordingly, the description is not intended to be exhaustive or to limit the principles described or illustrated herein to any precise form. Many modifications and variations are possible in light of the above teaching.

What is claimed:

1. An inflation system, comprising:
a solid-propellant gas generator; and
a gas motor having a turbine coupled to the solid-propellant gas generator and a compressor configured for coupling to an inflatable device.

2. The inflation system of claim 1, wherein the solid-propellant gas generator is coupled to the turbine via a first conduit.

3. The inflation system of claim 2, wherein the compressor is configured for coupling to the inflatable device via a second conduit.

4. The inflation system of claim 3, wherein the compressor is configured to receive a low pressure air from an atmosphere and compress the low pressure air to provide a compressed air stream for inflating the inflatable device.

5. The inflation system of claim 4, wherein the turbine is configured to receive a high pressure gas stream generated by the solid-propellant gas generator and to exhaust the high pressure gas stream as a turbine exhaust stream to the atmosphere.

6. The inflation system of claim 1, further comprising a manifold having a first inlet coupled to the turbine, a second inlet coupled to the compressor and an outlet configured for coupling to the inflatable device.

7. The inflation system of claim 6, wherein the first inlet is configured to receive a turbine exhaust stream exiting the turbine and the second inlet is configured to receive a compressed air stream exiting the compressor.

8. The inflation system of claim 7, wherein the outlet is configured to provide a mixed stream to the inflatable device, the mixed stream comprising the turbine exhaust stream and the compressed air stream.

9. The inflation system of claim 1, further comprising a heat exchanger configured to receive a turbine exhaust stream from the turbine and to output a cooled exhaust stream.

10. The inflation system of claim 9, further comprising a manifold having a first inlet coupled to the heat exchanger, a second inlet coupled to the compressor and an outlet configured for coupling to the inflatable device.

11. The inflation system of claim 10, wherein the first inlet is configured to receive the cooled exhaust stream exiting the heat exchanger and the second inlet is configured to receive a compressed air stream exiting the compressor.

12. The inflation system of claim 11, wherein the outlet is configured to provide a mixed stream to the inflatable device, the mixed stream comprising the cooled exhaust stream and the compressed air stream.

13. An evacuation system for an aircraft, comprising;
an evacuation slide;
a solid-propellant gas generator; and
a gas motor having a turbine coupled to the solid-propellant gas generator and a compressor coupled to the evacuation slide.

14. The evacuation system of claim 13, wherein the solid-propellant gas generator is coupled to the turbine via a first conduit and the compressor is coupled to the evacuation slide via a second conduit.

15. The evacuation system of claim 14, wherein the compressor is configured to receive a low pressure air from an atmosphere and compress the low pressure air to provide a compressed air stream for inflating the evacuation slide and the turbine is configured to receive a high pressure gas stream generated by the solid-propellant gas generator and to exhaust the high pressure gas stream as a turbine exhaust stream to the atmosphere.

16. The evacuation system of claim 13, further comprising a manifold having a first inlet coupled to the turbine and configured to receive a turbine exhaust stream exiting the turbine, a second inlet coupled to the compressor and configured to receive a compressed air stream exiting the compressor, and an outlet coupled to the evacuation slide and configured to provide a mixed stream to the evacuation slide, the mixed stream comprising the turbine exhaust stream and the compressed air stream.

17. The evacuation system of claim 13, further comprising a heat exchanger configured to receive a turbine exhaust stream from the turbine and to output a cooled exhaust stream and a manifold having a first inlet coupled to the heat exchanger, a second inlet coupled to the compressor and coupled to the evacuation slide and configured to provide a mixed stream to the evacuation slide, the mixed stream comprising the cooled exhaust stream from the heat exchanger and a compressed air stream from the compressor.

18. A method of inflating an evacuation slide, comprising;
igniting a solid-propellant housed within a container to generate a compressed gas;
routing the compressed gas through a turbine section of a gas motor to generate a compressed air stream via a compressor section connected to the turbine section; and
routing the compressed air stream to the evacuation slide.

19. The method of claim 18, wherein the routing the compressed air stream to the evacuation slide includes combining, in a manifold, the compressed air stream with an exhaust stream from the turbine section to form a mixed stream of the compressed air stream and the exhaust stream and routing the mixed stream to the evacuation slide.

20. The method of claim 18, wherein the routing the compressed air stream to the evacuation slide includes combining, in a manifold, the compressed air stream with a cooled exhaust stream from a heat exchanger coupled to the turbine section to form a mixed stream of the compressed air stream and the cooled exhaust stream and routing the mixed stream to the evacuation slide.
